(19) United States
(12) Patent Application Publication
(10) Pub. No.: US 2009/0072509 A1
(43) Pub. Date: Mar. 19, 2009

(54) RUNNING ASSISTING DEVICE

(75) Inventor: Kazuyuki Noboru, Shizuoka (JP)

Correspondence Address: KNOBBE MARTENS OLSON & BEAR LLP, 2040 MAIN STREET, FOURTEENTH FLOOR, IRVINE, CA, 92614, US

(73) Assignee: CLIMB TWO ONE LTD., Hamamatsu (JP)

(21) Appl. No.: 11/857,338

(22) Filed: Sep. 18, 2007

(51) Int. Cl. B62M 1/00

(52) U.S. Cl. 280/210

(57) ABSTRACT

A running assisting device can be formed by left and right paired halves each being worn on one foot of a rider and advanced with a rider alternately depressing stepping plates of the device, each half comprising frames (2, 3) each supporting a rear wheel (10) and front wheels (11) respectively; a stepping plate (1) moveable upward and downward relative to the frames (2, 3) on which a foot or a shoe (7) of a rider is laid; an energy storing device (6) including a spring (36) adapted to be compressed during the downward motion of the stepping plate (1) and returned to its extended condition when the stepping plate (1) reaches its lowermost or its nearly lowermost position for advancing the running assisting device by converting the returning force of the spring (36) to the rotational force of the rear wheel (10); and a power transmitting mechanism for permitting the downward motion of the stepping plate (1) to be transmitted to the rear wheel (10) via the energy storing device (6) but cutting off the upward motion of the stepping plate (1) from being transmitted to the rear wheel (10) characterized in that each half further comprises; a locking device (40) for limiting the upward motion of the stepping plate (1) by anchoring the stepping plate (1) to the frames (2, 3) when the stepping plate (1) has reached its lowermost or its nearly lowermost position, and an unlocking device (45) for permitting the upward motion of the stepping plate (1) by releasing the anchoring of the locking device (40) during the compressed energy storing device (6) returns to its extended position.

### BACKGROUND OF THE INVENTIONS

1. Field of the Inventions

The present inventions relate to running assisting devices, for example, devices formed with left and right paired halves each being worn on one foot of a rider for propelling or advancing a rider when a rider alternately depresses the stepping plates of the device.

2. Description of the Related Art

There are mainly two types running assisting devices, one type including roller skates having a stepping plate for supporting a foot of a rider thereon and rollers mounted on the under surface of the stepping plate and propelled by a rider's kicking force, and the other type which can be advanced by any other propelling means. One design of the type that can be propelled by stepping motion of a rider using his (or her) muscle force similar in walking is disclosed in Japanese Laid-open Patent Publication No. 73659/2004.

Each half of this running assisting device comprises a stepping plate connected to front and rear wheels via frames which are driven by a depressing force of a rider. A power transmitting mechanism permits downward motion of the stepping plate to be transmitted to the rear wheel but cuts off the upward motion of the stepping plate from being transmitted to the rear wheel. A spring is compressed during the downward motion of the stepping plate and is returned to its extended position when the stepping plate has reached its lowermost or nearly lowermost position.

### SUMMARY OF THE INVENTION

An aspect of at least one of the embodiments disclosed herein, includes the realizations that in this running assisting device, since the rear wheel can be driven by energy stored in a spring of the energy storing means while the stepping plate is lowered from its uppermost or its nearly uppermost position, the amplitude in variation of wheel speed can be suppressed and thus more stable running can be obtained. However there are still remained following problems.

If it is desired to obtain a large propelling force of the device by single depression (pressing down) of the stepping plate, it is preferable to use a spring having a large returning force. However the larger the returning force, the larger the depressing force. On the contrary if using a spring having a returning force substantially same as the weight of a rider, it is sufficient to have a large propelling force with alternately depressing the left and right stepping plates by using a rider's weight.

However when using a spring having a returning force substantially same as a rider's weight, the advancing distance of the device per depression is smaller due to the accelerating resistance at the commencement of running. Accordingly when a user tries to depress one stepping plate after the other formerly depressed stepping plate has reached its lowermost or nearly lowermost position, the weight of a rider would be separately supported on the left and right stepping plates. Thus the depressing force applied to one stepping plate would be reduced and the spring of the formerly depressed side would not be sufficiently extended.

Accordingly the returning force of the previously depressed spring would not be sufficiently transmitted to the rear wheel to drive it and retain a relatively large returning force therein. Thus since the retained returning force of the spring exceeds the depressing force applied thereto by a rider's weight, the associated stepping plate would be elevated. Accordingly in the running assisting device of the prior art the center of gravity of a rider would be also elevated. This causes instability both in a rider and the device at a time of commencement of running.

It is, therefore, an object of at least one of the present inventions to provide a running assisting device which can prevent the elevation of the stepping plate especially at a commencement of running to achieve the stable running of the device.

It is another object of at least one of the present inventions to achieve the stable running of the device by reducing a time at which the stepping plate is remained at the elevated position.

According to at least one of the embodiments disclosed herein, a running assisting device can be formed by left and right paired halves, each half being worn on one foot of a rider and advanced with a rider alternately depressing stepping plates of the device. Each half can comprise first and second frames, the first frame supporting a rear wheel and the second frame supporting front wheels. A stepping plate can be moveable upwardly and downwardly relative to the frames and can be configured to support a foot or a shoe of a rider. An energy storing means can include a spring adapted to be compressed during the downward motion of the stepping plate and returned to its extended condition when the stepping plate reaches its lowermost or its nearly lowermost position for advancing the running assisting device by converting the returning force of the spring to a rotational force of the rear wheel. A power transmitting mechanism can be configured to permit the downward motion of the stepping plate to be transmitted to the rear wheel via the energy storing means but cutting off the upward motion of the stepping plate from being transmitted to the rear wheel. Each half can further comprise locking means for limiting the upward motion of the stepping plate by anchoring the stepping plate to the frames when the stepping plate has reached its lowermost or its nearly lowermost position. Additionally, unlocking means can be provided for permitting the upward motion of the stepping plate by releasing the anchoring of the locking means when the compressed energy storing means returns to its extended position.

In accordance with another embodiment, a running assisting device can be formed by left and right paired halves, each half being worn on one foot of a rider and advanced with a rider alternately depressing stepping plates of the device. Each half can comprise first and second frames, the first frame supporting a rear wheel and the second frame supporting front wheels. A stepping plate can be moveable upwardly and downwardly relative to the frames and configured to support a foot or a shoe of a rider. An energy storing device can include a spring adapted to be compressed during the downward motion of the stepping plate and returned to its extended condition when the stepping plate reaches its lowermost or its nearly lowermost position, the energy storing device being configured to advance the running assisting device by converting the returning force of the spring to a rotational force of the rear wheel. A power transmitting mechanism can be configured to transmit the downward motion of the stepping plate to the rear wheel via the energy storing device and to cut off the upward motion of the stepping plate from being transmitted to the rear wheel. Each half can further comprises a locking device configured to limit the upward motion of the stepping plate by anchoring the stepping plate to the frames when the stepping plate has reached its lowermost or its nearly lowermost position. An unlocking device can be configured to release the anchoring of the locking means when the compressed energy storing means returns to its extended position so as to permit the upward motion of the stepping plate.

### BRIEF DESCRIPTION OF THE DRAWINGS

Additional advantages and features of the present inventions will become apparent from the subsequent description and the appended claims, taken in conjunction with the accompanying drawings, wherein:

FIG. 1 is a schematic side elevation view of the running assisting device of an embodiment;

FIG. 2 is a schematic plan view of the running assisting device of FIG. 1;

FIG. 3 is an enlarged schematic view showing a region in which a locking device and an unlocking device are arranged;

FIG. 4 is a schematic front elevation view of a steering device of the running assisting device;

FIG. 5 is a schematic view of a braking device and an operating lever of the running assisting device showing a condition in which the braking device is pushed on a rear wheel;

FIG. 6 is a schematic view of a braking device and an operating lever of the running assisting device showing a condition in which the braking device is separated from a rear wheel;

FIGS. 7(a) and 7(b) are a schematic side elevation view and partially enlarged schematic view respectively showing one depressing process relative to the stepping plate of the running assisting device;

FIGS. 8(a) and 8(b) are a schematic side elevation view and partially enlarged schematic view respectively showing another depressing process relative to the stepping plate of the running assisting device;

FIGS. 9(a) and 9(b) are a schematic side elevation view and partially enlarged schematic view respectively showing another depressing process relative to the stepping plate of the running assisting device;

FIGS. 10(a) and 10(b) are a schematic side elevation view and partially enlarged schematic view respectively showing another depressing process relative to the stepping plate of the running assisting device;

FIGS. 11(a) and 11(b) are a schematic side elevation view and partially enlarged schematic view respectively showing another depressing process relative to the stepping plate of the running assisting device; and

FIG. 12 is a schematic side elevation view of the running assisting device of another embodiment.

### DETAILED DESCRIPTION OF THE PREFERRED EMBODIMENT

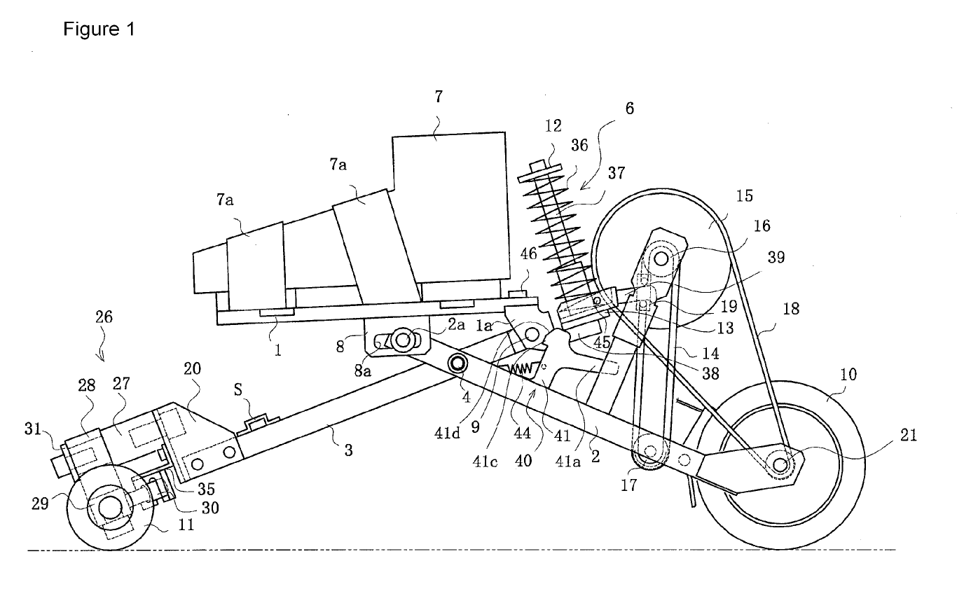

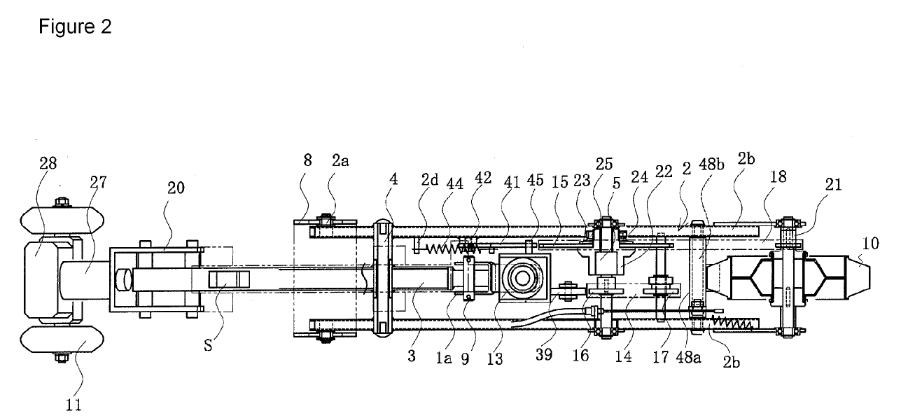

The running assisting devices described below can comprise left and right paired halves each adapted to be worn on one foot of a rider and can be advanced with a rider alternately depressing stepping plates of two halves. Each half of the running assisting device can comprise a stepping plate 1, a first frame 2 supporting a rear wheel 10, a second frame 3 supporting a front wheel 11, a pivotal shaft 4, a one-way clutch 5, an energy storing device 6, and a steering device 26 as shown in FIGS. 1 and 2.

The stepping plate 1 can include, on its upper surface, a fastening device 7a for fastening a shoe 7 of a rider and, on its under surface, a supporting bracket 8 for supporting one end (forward end i.e. left-hand end of FIG. 1) of the first frame 2. Another bracket 1a can be provided on the rear end of the stepping plate 1 for pivotably supporting end of the second frame 3 via a pivotal shaft 9. A horizontally (i.e. a left-right direction in FIG. 1) extending elongated hole 8a can be formed in the bracket 8 in which a pin 2a mounted on one end of the first frame 2 can be supported so that it move horizontally.

The first frame 2 can extend rearwardly from the bracket 8 and the rear wheel 10 can be supported on its rear ends. The first frame 2 can comprise two straight frames 2b arranged substantially in parallel each other and a lateral shaft 48b for connecting the frames 2b as shown in FIG. 2. Mounted on the first frame 2 can be a power transmitting mechanism including a one-way clutch for converting a swing motion of the first frame 2 around the pivotal shaft 4 to a rotation of the rear wheel 10. As can be seen in FIG. 1, the pivotal shaft 4 can swingably support the first and second frames 2 and 3 at a crossing point of them and vertically move in accordance with the vertical motion of the stepping plate 1.

The power transmitting mechanism can be configured to permit the downward motion of the stepping plate 1 to be transmitted to the rear wheel 10 via an energy storing device 6 described below in more detail, but to also cut off the upward motion of the stepping plate 1 from being transmitted to the rear wheel 10. More specifically the power transmitting mechanism can comprise a one-way clutch 5, a chain 14 extending between two sprockets 16 and 16, a chain 18 extending between two sprockets 15 and 21, and a securing member 19. The sprocket 16 can be mounted on the rotational shaft of the sprocket 15 co-axially therewith so that the rotation of the sprocket 16 only in an advancing direction can be transmitted to the sprocket 15 via the one-way clutch 5. All the sprockets can be supported via bearings.

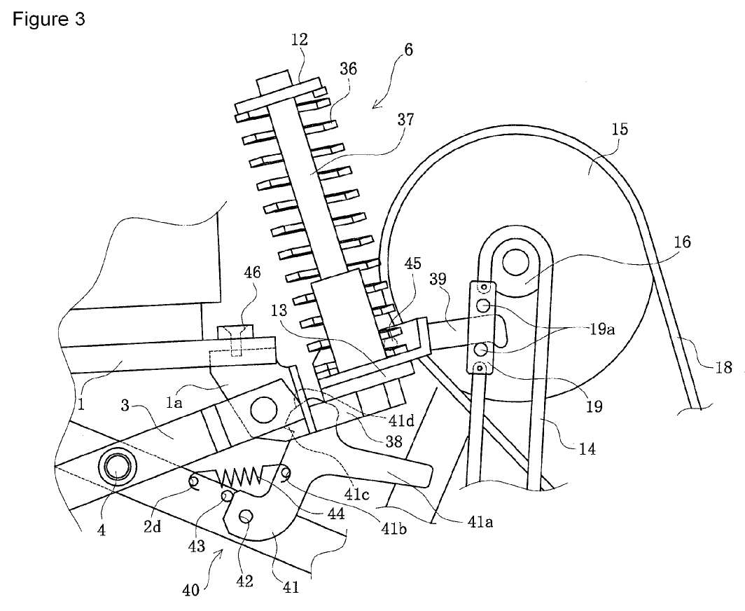

Mounted on the securing member 19 can be a pair of rollers 19a between which a tip end of the second frame 3 (more in detail a tip end of a pinned member 39 of the energy storing device 6) (see FIG. 3). The pinned member 39 can be connected to a supporting member 38 via a moveable bush 13 and the supporting member 38 can be connected to a tip end of the second frame 3 and thus the chain 14 can be driven in accordance with the movement of the second frame 3.

The one-way clutch 5 can be configured to transmit only a force forwardly driving the rear wheel 10 and not to transmit a force of reverse direction. For example, a ratchet wheel conventionally used in a bicycle may be used. As shown in FIG. 2 the one-way clutch 5 can be supported on its circumferential surface by a housing 22. The end portion of the housing 22 can be pressed against the sprocket 15 by a belleville spring 23 via a washer 24. The housing 22, sprocket 15, washer 24 and belleville spring 23 can function as a torque limiter for preventing breakage of the running assisting device when an excessive load is applied thereto by the housing 22, sprocket 15, washer 24 and belleville spring 23 or when the rear wheel 10 is rotated in reverse. Numeral 25 denotes an adjusting nut for adjusting the pressing force of the belleville spring 23.

The energy storing device 6 can be configured to store the energy generated during the depressing process of the stepping plate 1 from its uppermost or nearly uppermost position and release the stored energy at a time of arrival of the stepping plate 1 at its lowermost or nearly lowermost position in order to drive the rear wheel 10. The energy storing device 6 can comprise a spring 36, the moveable bush acting as a seat for the spring 36, a bush 12, a rod 37 extending through the spring 36, and the supporting member 38 secured on the tip end of the second frame 3. However, other configurations can also be used.

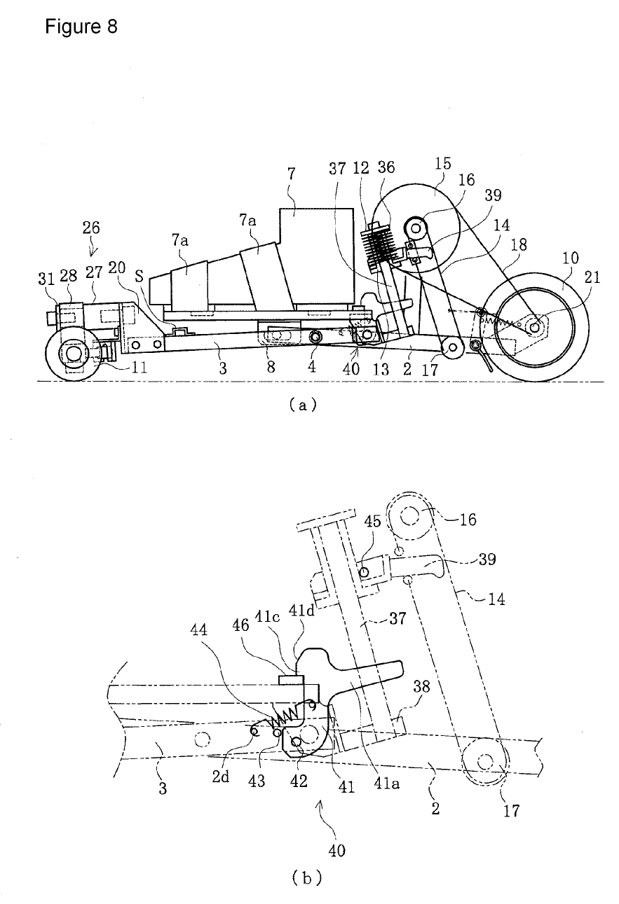

One end of the rod 37 can be secured on the supporting member 38 and the other end thereof can support the bush 12. The moveable bush 13 can be connected to the chain 14 via the pinned member 39 and moveable between the bush 12 and the supporting member 38. Thus when the tip end of the second frame 3 is lowered in accordance with depression of the stepping plate 1, the securing member 19 can also be lowered by the pinned member 39 with the spring 36 being compressed (see FIG. 8).

When the stepping plate 1 reaches its lowermost or nearly lowermost position, the amount of compression of the spring 36 becomes maximum and the spring 36 stores a maximum elastic energy.

Then the spring 36 returns toward its extended position and the moveable bush 13 is lowered until it abuts the supporting member 38. During this movement, the pinned member 39 is also lowered together with the chain 14 and rotates sprockets 16 and 17 and this rotation can be transmitted to the sprocket 15. If this rotational force is excessive, transmission of the rotational force can be limited by generation of slippage between the housing 22 and the sprocket 15.

The rotation of the sprocket 15 causes rotation of a shaft 10a of the rear wheel 10 and propels the running assisting device forwardly. On the other hand, when the stepping plate 1 is elevated after its arrival at its bottom dead center, the first and second frames 2 and 3 are also elevated from the position of FIG. 8. Thus the sprocket 16 can be rotated in a direction reverse to said forward direction via the chain 14, however, transmission of rotational force of the sprocket 16 to the rear wheel 10 can be cut off by the one-way clutch 5.

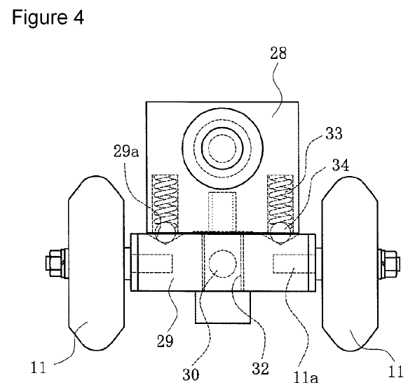

The second frame 3 can extend forwardly from the pivotal shaft 9 and can be mounted at its tip end the front wheel 11 via the steering device 26 as shown in FIGS. 1 and 4. The steering device 26 can steer the front wheel 11 when the second frame 3 is inclined in accordance with inclination of the stepping plate 1.

The steering device 26 can comprise a connecting shaft 27 mounted on the tip end of the second frame 3 at a position offset from the axis of the second frame 3, an upper frame 28 rotatably supporting the connecting shaft 27 around its supporting shaft, a lower frame 29 mounted on the upper frame 28 rotatably within a plane parallel to a floor and supporting two front wheels 11 in parallel with each other via axles 11a, and an arm pin 30 extending from the tip end of the second frame 3 to the lower frame 29 for changing the inclination of the second frame 3 to that of the lower frame 29.

The upper frame 28 can be rotatably mounted on the tip end of the connecting shaft 27 by a securing washer 31 and the lower frame 29 can be mounted on the upper frame 28 by a pin 32 inserted from the under side of the lower frame 29 rotatably within a plane parallel to a floor. The arm pin 30 can be fitted in a rotary bracket 35 secured on the tip end of the second frame 3 and mounted on the lower frame 29.

Owing to the structure mentioned above, when a rider tries to incline his foot to turn the travelling direction, both the first and second frames 2 and 3 also incline via the stepping plate 1. During this movement, the second frame 3 can rotate around the connection to the upper frame 28 and the arm pin 30 can also rotate in accordance with the rotation of the second frame 3 with urging the lower frame 29. As a result, the urged lower frame 29 can be steered so that it is directed toward a direction in which a foot of rider has been inclined, i.e. a direction inside of the turn. Accordingly a smoother turn can be achieved since the front wheels 11 can be submissively steered toward a direction in which a foot of rider is inclined.

Balls 34 urged by springs 33 can be arranged at an interface between the upper and lower frames 28 and 29 so that balls 34 are fitted in recesses 29a formed on the upper surface of the lower frame 29 in a condition in which the front wheels 11 direct straightly forward. This enables a smooth return the direction of the front wheels 11 after completion of turn to the usual direction (i.e. straightly forward direction).

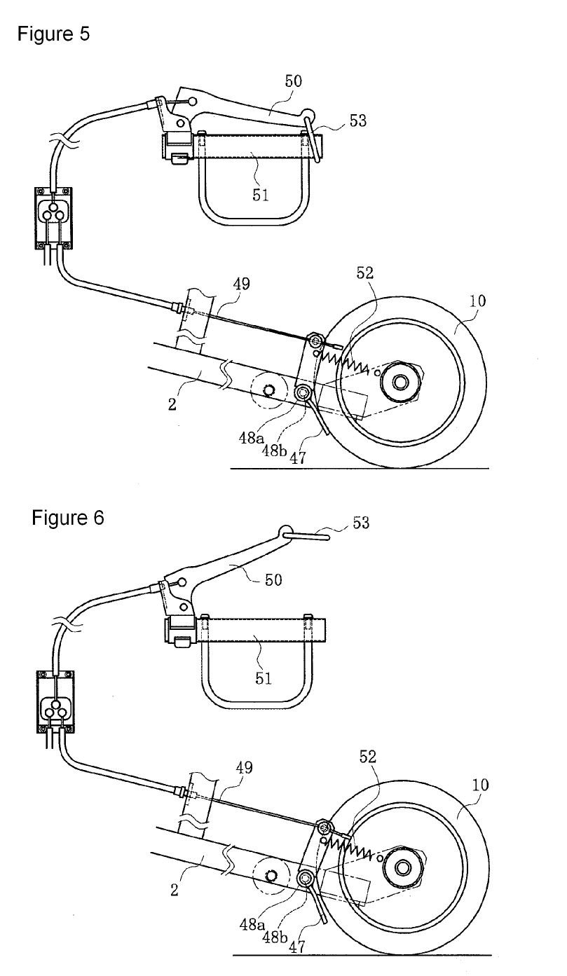

The lateral shaft 48b can be arranged on the first frame 2 near the rear wheel 10 as shown in FIGS. 5 and 6. A collar 48a having a braking device 47 can be pivotably mounted on the shaft 48b. The braking device 47 can be operated by a operating lever 50 via a wire 49 between a braked position (contacted position of FIG. 5) and a non-braked position (detached position of FIG. 6) to brake the rear wheel 10.

The operating lever 50 can be pivoted on a gripping bar 51 and a rider can brake the rear wheel 10 by gripping the bar 51 and closing the lever 50 relative to the gripping bar 51 in order to shift the braking device 47 to the braked position via the wire 49. On the contrary when a rider releases his hand from the operating lever 50, the braking device 47 can be returned to its non-braked position by a spring 52.

The running assisting device can be kept immovable when a rider wears the device on his foot by gripping the operating lever 50 and anchoring a holding device 53 on the gripping bar 51 as shown in FIG. 5. This can further improve the safety of the running assisting device.

As shown in FIG. 3 the running assisting device can be provided with a locking device 40 for limiting the upward motion of the stepping plate 1 by anchoring the stepping plate 1 to the first frame 2 at a time when the stepping plate 1 has reached its lowermost or nearly lowermost position, and an unlocking pin 45 for permitting the upward motion of the stepping plate 1 by releasing the locking device 40 during the compressed energy storing device 6 returns to its extended position. A stopper 46 can be arranged at the rear end of the stepping plate 1 so that it vertically projects therefrom.

For example, the locking device 40 can comprise a swing member 41 swingably mounted on a pivot pin 42 mounted on the first frame 2 and the swing member 41 can include an arm portion 41a, a claw portion 41c and an “R” portion 41d. One end of a return spring 44 can be anchored to an anchoring portion 41b on the swing member 41 and the other end of the return spring 44 can be anchored to an anchoring portion on the first frame 2. Accordingly the swing member 41 can be biased toward an anti-clockwise direction (viewed in FIG. 3) around the pivot pin 42 by the spring 44 and can be abutted against a stopper pin 43 on the first frame 2 to prevent further rotation in anti-clockwise direction.

The claw portion 41c can be configured to engage the stopper portion 46 on the stepping plate 1 when the stepping portion 1 has reached its lowermost or nearly lowermost position as shown in FIG. 8(b). This engagement (anchoring) of the claw 41c with the stopper 46 limits the elevation of the stepping plate 1. This prevents the formerly depressed stepping plate 1 from being elevated (such an elevation is often seen in conventional running assisting devices) although the left and right stepping plates 1 are alternately depressed at the commencement of running when the spring 36 having its returning force substantially same as the weight of a rider is used.

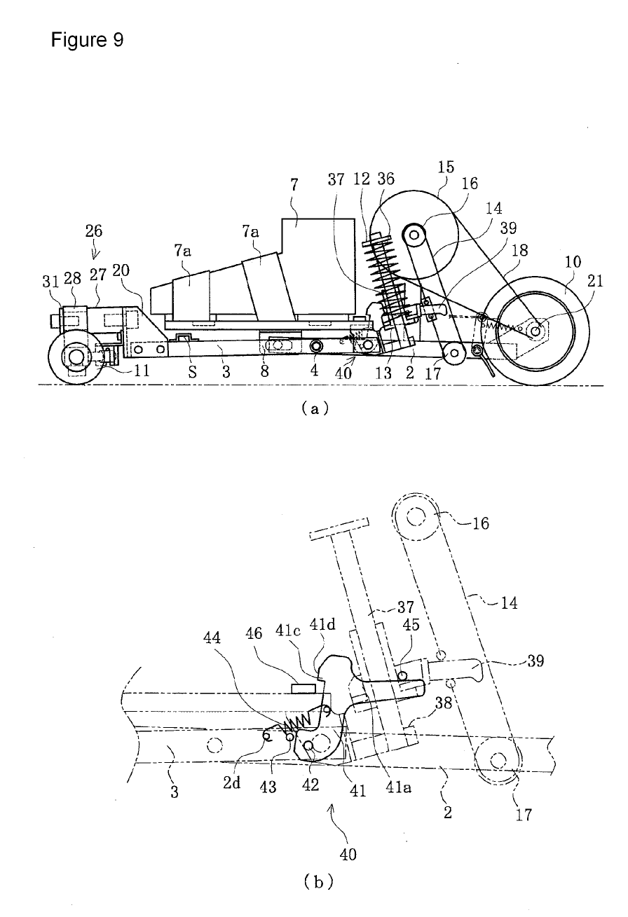

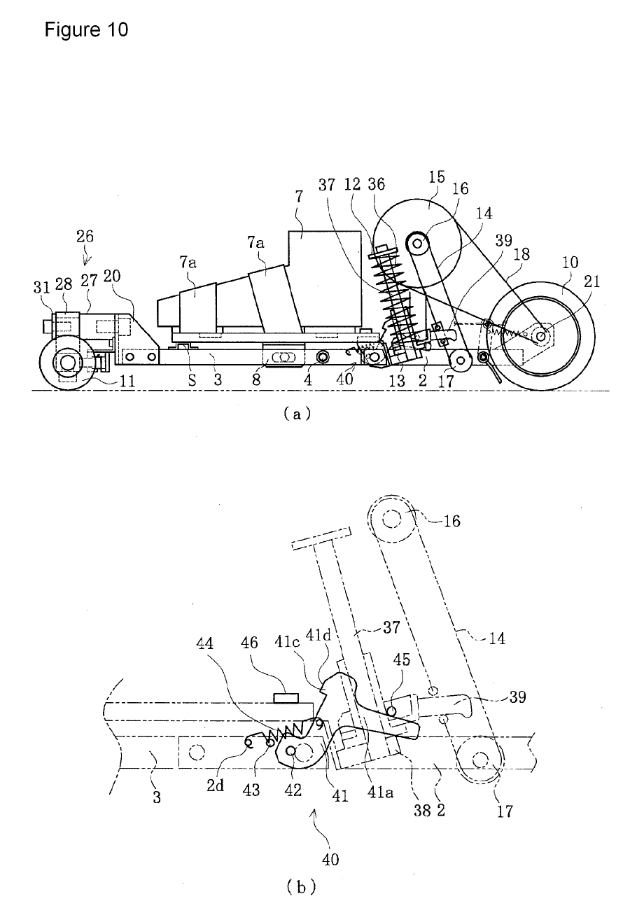

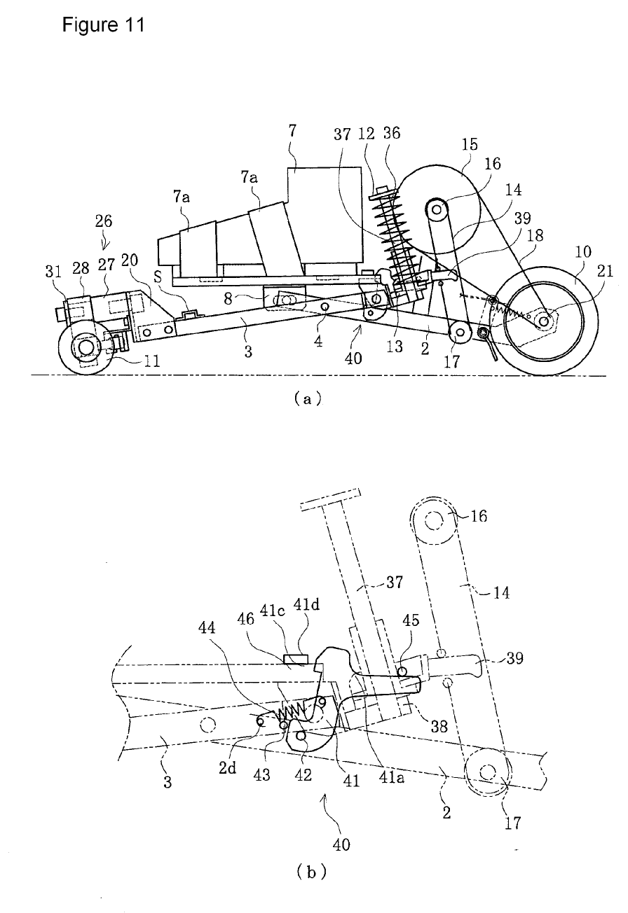

The unlocking pin 45 can extend horizontally from the wall of the moveable bush 13 of the energy storing device 6 (see FIG. 2) and can be elevated or lowered in accordance with the compression or extension of the spring 36 of the energy storing device 6 so as to cause swing motion of the swing member 41 by abutting against the arm portion 41a of the swing member 41 during downward movement of the unlocking pin 45. When the swing member 41 is caused to move in the swing motion, the claw 41c can be detached from the stopper 46 to release their anchoring as shown in FIGS. 9(b) and 10(b).

That is, the elevation of the stepping plate 1 can be limited by the anchoring of the claw portion 41c to the stopper portion 46 when the stepping plate 1 has reached its lowermost or nearly lowermost position, and on the other hand the elevation of the stepping plate 1 can be permitted by the release of anchoring of the claw 41 with abutment of the unlocking pin 45 against the arm 41a when the spring 36 of the energy storing device 6 can be extended a predetermined length. Accordingly this makes it possible not only to achieve a stable running by preventing the elevation of the stepping plate 1 at the commencement of running but to carry out continuous depression of the stepping plate 1 thereafter.

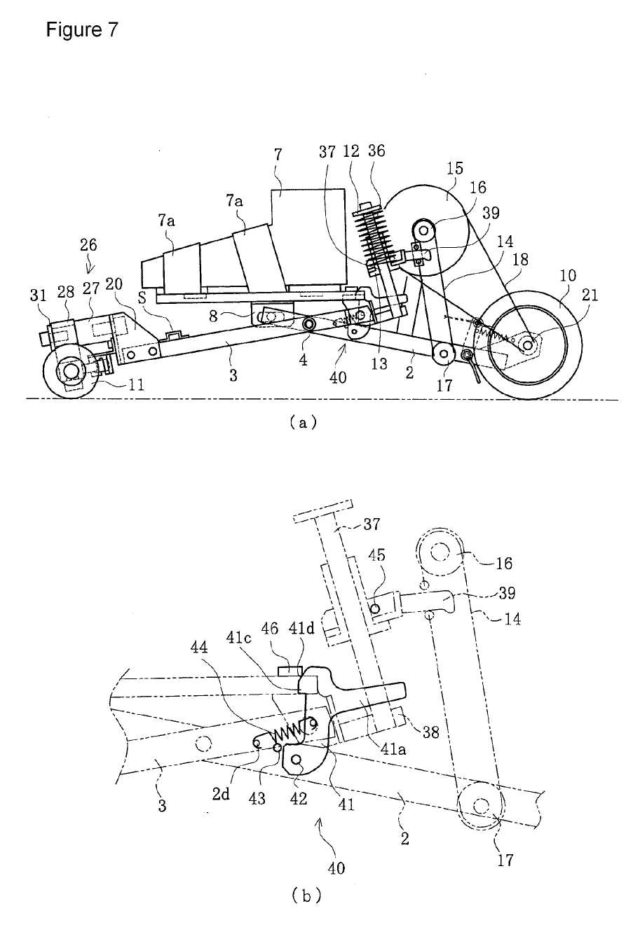

During operation, firstly, when a rider depresses the stepping plate 1 from a condition shown in FIG. 1, the spring 36 of the energy storing device 6 is compressed and the “R” portion 41d of the swing member 41 abuts against the stopper portion 46 as shown in FIGS. 7(a) and 7(b). When the stepping plate 1 is further depressed and reaches its lowermost or nearly lowermost position, the swing member 41 can be slightly swung toward the clockwise direction around the pivot pin 42 owing to the configuration of the “R” portion 41d and then returned by the return spring 44 and the claw 41c can be anchored to the stopper 46 (see FIG. 8).

Thus when the stepping plate 1 occupies the condition in which its elevation is limited, the spring 36 of the energy storing device 6 can be returned to its extended position and the returning force drives the pinned member 39 to rotate the rear wheel 10 to drive the device forward as previously mentioned. At a point of time in which the spring 36 is extended a predetermined length and the returning force is progressively weakened, the unlocking pin 45 can be lowered and can abut against the arm portion 41a of the swing member 41 and the further descent of the unlocking pin 45 causes the swing motion of the swing member 42 as shown in FIG. 10. Thus since the claw portion 41c detaches from the stopper portion 46 and the anchoring can be released owing to the swing motion of the swing member 41, the elevation of the stepping plate 1 can be permitted.

In some embodiments, since the elevation of stepping plate 1 can be limited at a point of time in which the stepping plate 1 has reached its lowermost or nearly lowermost position and the elevation of the stepping plate 1 can be permitted by the unlocking means during the spring 36 of the energy storing device 6 can be returned to its extended position, it is possible to achieve the stable running of the device with preventing the elevation of the stepping plate 1 especially at the commencement of running.

Additionally, in some embodiments including the braking device 47 for braking the rear wheel 10, it can be possible to move the device in a condition of low center of gravity with keeping the rear wheel 10 in a braked state by depressing the stepping plate 1 to its lowermost or nearly lowermost position with keeping the rear wheel 10 braked by the braking device 47 and by making the swing member 41 prevent the stepping plate 1 from being elevated. Accordingly it is also possible to use the braking device 47 other than braking, for example, to move the device through a narrow place in which the radius of gyration of the device can be too large to pass through.

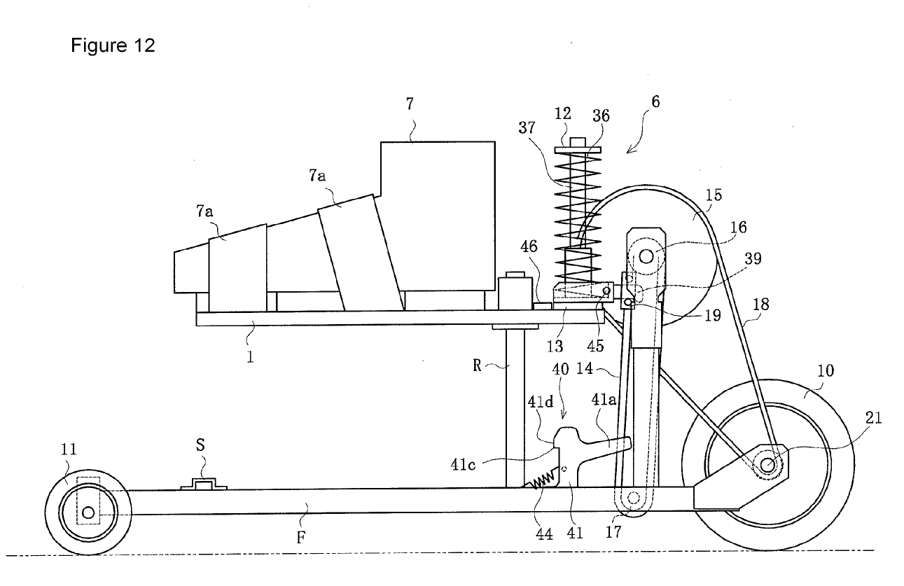

Although preferred embodiments are described above, the present inventions are not limited thereto and several modifications may be added. For example, at least some of the present inventions can be applied to a running assisting device shown in FIG. 12 formed by a frame “F” having a front wheel 11 at its front end and a rear wheel 10 at its rear end, a stepping plate 1 on which a foot of a rider can be placed, a rod “R” supporting the stepping plate 1 moveably in vertical relative to the frame “F”, and a spring 36 which is adapted to be compressed during the stepping plate 1 can be depressed and commences returning to its extended position at a time of the stepping plate 1 being depressed to its lowermost or nearly lowermost position.

In this case it is possible to make the device of FIG. 12 to achieve at least some of the effects as those of the previous embodiment by providing a swing member 41 similar to the previous embodiment on the frame “F” so as to enable the swing member 41 to anchor a stopper portion 46 to limit elevation of the stepping plate 1 and also to allow elevation of the stepping plate 1 by providing an unlocking pin 45 so as to release the anchoring of a claw portion 41c of the swing member 41 during the spring 36 returns to its extended position.

### APPLICABILITY IN INDUSTRY

The present inventions can be applied to any other running assisting device having different appearances in configuration and additional functions so long as it is a running assisting device which has a locking device for anchoring the stepping plate to the frame to limit elevation of the stepping plate at a time the stepping plate has reached its lowermost or nearly lowermost position, and the unlocking device for releasing the locking device when the energy storing device returns to its extended position to allow elevation of the stepping plate.

What is claimed is:

1. A running assisting device formed by left and right paired halves, each half being worn on one foot of a rider and advanced with a rider alternately depressing stepping plates of the device, each half comprising
first and second frames, the first frame supporting a rear wheel and the second frame supporting front wheels;
a stepping plate moveable upwardly and downwardly relative to the frames and configured to support a foot or a shoe of a rider;
an energy storing means including a spring adapted to be compressed during the downward motion of the stepping plate and returned to its extended condition when the stepping plate reaches its lowermost or its nearly lowermost position for advancing the running assisting device by converting the returning force of the spring to a rotational force of the rear wheel; and
a power transmitting mechanism configured to permit the downward motion of the stepping plate to be transmitted to the rear wheel via the energy storing means but cutting off the upward motion of the stepping plate from being transmitted to the rear wheel;
wherein each half further comprises locking means for limiting the upward motion of the stepping plate by anchoring the stepping plate to the frames when the stepping plate has reached its lowermost or its nearly lowermost position; and
an unlocking means for permitting the upward motion of the stepping plate by releasing the anchoring of the locking means when the compressed energy storing means returns to its extended position.

2. A running assisting device of claim 1, wherein the unlocking means comprises an unlocking pin moveable in accordance with the compression and extension of the energy storing means, the locking means comprising a swing member including a claw portion adapted to be anchored to a stopper portion formed on the stepping plate and an arm portion adapted to abut the unlocking pin during movement of the unlocking pin, and the unlocking pin being configured to unlock the anchoring of the claw portion from the stopper portion by making the claw portion separate from the stopper portion by a swing motion of the swing member caused by abutment of the unlocking pin against the arm portion.

3. A running assisting device formed by left and right paired halves, each half being worn on one foot of a rider and advanced with a rider alternately depressing stepping plates of the device, each half comprising
first and second frames, the first frame supporting a rear wheel and the second frame supporting front wheels;
a stepping plate moveable upwardly and downwardly relative to the frames and configured to support a foot or a shoe of a rider;
an energy storing device including a spring adapted to be compressed during the downward motion of the stepping plate and returned to its extended condition when the stepping plate reaches its lowermost or its nearly lowermost position, the energy storing device being configured to advance the running assisting device by converting the returning force of the spring to a rotational force of the rear wheel; and
a power transmitting mechanism configured to transmit the downward motion of the stepping plate to the rear wheel via the energy storing device and to cut off the upward motion of the stepping plate from being transmitted to the rear wheel;
wherein each half further comprises a locking device configured to limit the upward motion of the stepping plate by anchoring the stepping plate to the frames when the stepping plate has reached its lowermost or its nearly lowermost position; and
an unlocking device configured to release the anchoring of the locking means when the compressed energy storing means returns to its extended position so as to permit the upward motion of the stepping plate.

4. A running assisting device of claim 3, wherein the unlocking device comprises an unlocking pin moveable in accordance with the compression and extension of the energy storing device, the locking device comprising a swing member including a claw portion adapted to be anchored to a stopper portion formed on the stepping plate and an arm portion adapted to abut the unlocking pin during movement of the unlocking pin, and the unlocking pin being configured to unlock the anchoring of the claw portion from the stopper portion by making the claw portion separate from the stopper portion by a swing motion of the swing member caused by abutment of the unlocking pin against the arm portion.
